(19) United States
(12) Patent Application Publication
(10) Pub. No.: US 2015/0376556 A1
(43) Pub. Date: Dec. 31, 2015

(54) WATER-SOLUBLE POUCH

(71) Applicant: The Procter & Gamble Company, Cincinnati, OH (US)

(72) Inventors: Ryohei OHTANI, Nishinomiya (JP); Katrien VAN ROEY, Werchter (BE); Qiupeng YAO, Beijing (CN)

(21) Appl. No.: 14/337,274

(22) Filed: Jul. 22, 2014

(30) Foreign Application Priority Data
Jun. 30, 2014 (CN) PCT/CN2014/081161

(51) Int. Cl. C11D 17/04; C11D 3/48

(52) U.S. Cl. CPC C11D 17/043; C11D 3/48; C11D 17/045

(57) ABSTRACT

A water-soluble pouch, comprising a water-soluble film and a liquid detergent composition contained within the water-soluble film, wherein the liquid detergent composition comprises: by weight of the composition, from 0.001% to 3% of a nonionic anti-microbial agent and from 1% to 12% of water. The water-soluble pouch provides a good anti-microbial benefit, without compromising its stability.

### FIELD OF THE INVENTION

The present invention relates to a water-soluble pouch comprising a water-soluble film and a liquid detergent composition contained within the water-soluble film.

### BACKGROUND OF THE INVENTION

Water-soluble pouches have become popular of late in fields such as detergents for domestic use. This product is conveniently packaged in a water-soluble film, thereby reducing any incidental contact between the user's hand and the detergent. Also, by providing a unitary dose of detergent, the product eliminates the need for the user to measure the suitable amount of detergent for a required operation, e.g., a laundry wash cycle. Instead, the product can simply be added to a wash basin or laundry machine, in which the contained detergent of the product disperses after the film solubilizes upon contacting water.

Such water-soluble pouches are typically made using a transparent or translucent film, allowing the user to see the detergent contained within the pouch. Pouches with a liquid composition are particularly attractive to users as they tend to provide a premium aesthetics and soft tactile feel to users when handling the product. However, such a liquid content poses formulation challenges: the liquid composition within the pouch must be anhydrous or contain a controlled amount of water so as not to prematurely solubilize the water-soluble film. Specifically, the total water content of a liquid composition in a water-soluble pouch is critical to pouch stability particularly under hot and humid manufacturing or storage conditions. Generally the higher the water content the less stable the pouch becomes. When this happens the pouch has a floppy appearance, which users perceive negatively. Thus, formulators are faced with the difficult technical challenge to reduce total water content in the composition of a water-soluble pouch.

However, a big limitation in meeting this challenge comes from water introduced into the formulation via raw material ingredients. Many of these ingredients are desired or necessary since they deliver certain unique functions, e.g., an anti-microbial agent that enables an anti-microbial detergent product. To achieve its intended function, an ingredient must be present above a certain active level. As such, a relatively high level of the ingredient may necessarily bring a high level of water thereby, resulting in decreased stability of the pouch. The problem is particularly severe when it comes to anti-microbials because many known anti-microbial agents require a relatively high active level and typically come in aqueous solutions (i.e., in their raw material forms). Removing water from raw material forms is generally expensive, e.g., given energy demanded in removing water or chemical stability issues subjecting the raw material through water removing processes.

Thus, there is a need for a liquid-contained water-soluble pouch that provides a good anti-microbial benefit, without compromising its stability.

It is an advantage of the present invention to provide an anti-microbial water-soluble pouch that comprises a concentrated liquid detergent composition.

It is another advantage of the present invention to provide an anti-microbial water-soluble pouch that comprises an anti-microbial active that has flexible film compatibility or formulation compatibility, i.e., the anti-microbial agent not undesirably reacting with the water-soluble film or other formulated ingredients.

### SUMMARY OF THE INVENTION

The present invention is directed to a water-soluble pouch, comprising a water-soluble film and a liquid detergent composition contained within the water-soluble film, wherein the composition comprises:

a) from 0.001% to 3%, by weight of the composition, of a nonionic anti-microbial agent; and

b) from 1% to 12%, by weight of the composition, of water.

In another aspect, the present invention is directed to a method of making a water-soluble pouch comprising a liquid detergent composition comprising the steps:

a) adding an anti-microbial composition into a liquid composition precursor to form the liquid detergent composition, wherein the anti-microbial composition comprises a nonionic anti-microbial agent and less than 5% of water by weight of the anti-microbial composition; and

b) encapsulating the liquid detergent composition with a water-soluble film to form the water-soluble pouch.

### DETAILED DESCRIPTION OF THE INVENTION

In the present invention, it has been surprisingly found that, by incorporating a particular type of anti-microbial agent, at a certain water level, the water-soluble pouch of the present invention demonstrates both a good anti-microbial benefit and film stability portfolio. Without wishing to be bound by theory, it is believed that due to its nonionic and hydrophobic property, the selected anti-microbial agent herein does not require an aqueous solution in its raw material form, i.e., it can be formulated as a water-free or low water raw material form. Such a water-free or low water form minimizes the total amount of water in the formulation as a whole. Thus, the nonionic anti-microbial agent significantly increases the formulating flexibility and enables a liquid-contained, anti-microbial water-soluble pouch, without compromising the pouch stability.

### DEFINITIONS

As used herein, the term “liquid detergent composition” means a liquid composition relating to cleaning or treating: fabrics, hard or soft surfaces, skin, hair, or any other surfaces in the area of fabric care, home care, skin care, and hair care. Examples of the detergent compositions include, but are not limited to: laundry detergent, laundry detergent additive, fabric softener, carpet cleaner, floor cleaner, bathroom cleaner, toilet cleaner, sink cleaner, dishwashing detergent, air care, car care, skin moisturizer, skin cleanser, skin treatment emulsion, shaving cream, hair shampoo, hair conditioner, and the like. Preferably, the liquid detergent composition is a liquid laundry detergent composition or a liquid dishwashing detergent composition, but preferably is a liquid laundry detergent composition. The liquid detergent composition may be either aqueous or non-aqueous, and may be anisotropic, isotropic, or combinations thereof.

As used herein, the term “pouch” refers to a type of detergent product comprising a water-soluble film and a detergent composition contained in the water-soluble film. The term “compartment” herein refers to a portion of the pouch in which a detergent composition is enveloped by the water-soluble film.

As used herein, the term “anti-microbial agent” refers to a chemical compound of which the principle intended function is to kill bacteria or to prevent their growth or reproduction. Anti-microbial agents include cationic anti-microbial agents (e.g., certain ammonium chlorides), nonionic anti-microbial agents, etc. Diphenyl ether compounds that are used in the present invention are nonionic anti-microbial agents.

As used herein, the term “water” refers to the actual amount of water present in the liquid detergent composition of the present invention. The water can be of any form, including free water that is available to the water-soluble film, water that is held within a gelled matrix (e.g., a structurant in the composition), water of solvation of any components present in the composition, etc. The water can be either intentionally added into the composition or come with raw materials.

As used herein, the term “washing solution” refers to the typical amount of aqueous solution used for one cycle of laundry washing, preferably from 1 L to 50 L, alternatively from 1 L to 20 L for hand washing and from 20 L to 50 L for machine washing.

As used herein, the term “alkyl” means a hydrocarbyl moiety which is branched or unbranched, substituted or unsubstituted. Included in the term “alkyl” is the alkyl portion of acyl groups.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

### Liquid Detergent Composition

The liquid detergent composition of the present invention comprises: by weight of the composition, from 0.001% to 3% of a nonionic anti-microbial agent, and from 1% to 12% of water.

Preferably in the liquid detergent composition, the nonionic anti-microbial agent is present from 0.01% to 1%, more preferably from 0.03% to 0.5%, by weight of the composition. The water is preferably present from 3% to 11%, more preferably from 5% to 11%, by weight of the composition. In particular, since a relatively low water level is maintained, the composition herein can be formulated as a concentrated liquid detergent composition.

In a washing solution, the liquid detergent composition is preferably capable of delivering the anti-microbial agent at a level from 0.01 ppm to 5 ppm, more preferably from 0.05 ppm to 3 ppm, more preferably from 0.1 ppm to 1 ppm.

Preferably, the composition herein provides anti-microbial benefits against both Gram positive bacteria (e.g., Staphylococcus aureus) and Gram negative bacteria (e.g., Klebsiella pneumoniae). The composition preferably provides residual anti-microbial benefits to the fabrics treated by the composition, i.e., the nonionic anti-microbial agent therein deposits onto the fabrics during a wash cycle and subsequently the deposited (i.e., residual) antimicrobial-agent prevents bacteria growth onto the fabrics during drying or storage or wear. In one embodiment, the liquid detergent composition provides a Bacteriostatic Activity Value of at least a log 2.2 reduction against both Gram positive bacteria and Gram negative bacteria, to treated fabrics versus non-treated fabrics. Preferably, the composition provides at least a log 2.2 reduction against Staphylococcus aureus and/or Klebsiella pneumoniae after a 10 minutes contact time in a 2069 ppm aqueous solution as determined by the JISL 1902 method (that is described below). More preferably, the composition provides at least log 2.2 reduction against Staphylococcus aureus. It is worth noting that Staphylococcus aureus is frequently found on human skin and therefore fabrics (particularly wearing fabrics) are in particular need of anti-microbial effects against Staphylococcus aureus.

The liquid detergent composition herein may be acidic or alkali or pH neutral, depending on the ingredients incorporated in the composition. The pH range of the composition is preferably from 6 to 12, more preferably from 7 to 10, even more preferably from 7 to 9.

The composition herein can have any suitable viscosity depending on factors such as formulated ingredients and purpose of the composition. In one embodiment, the composition has a high shear viscosity value, at a shear rate of 20/sec and a temperature of 21° C., of 100 to 3,000 cP, alternatively 300 to 2,000 cP, alternatively 500 to 1,000 cP, and a low shear viscosity value, at a shear rate of 1/sec and a temperature of 21° C., of 500 to 100,000 cP, alternatively 1000 to 10,000 cP, alternatively 1,300 to 5,000 cP.

Nonionic Anti-Microbial Agent

The anti-microbial agent of the present invention is nonionic. In the present invention, it has been found that due to its nonionic property, the anti-microbial agent of the present invention allows for a stable, liquid anti-microbial laundry detergent composition. By contrast, traditional cationic anti-microbial agents are typically not compatible with anionic surfactants present in liquid laundry detergent compositions. Moreover, due to its water-free raw material form and hydrophobic property, the nonionic anti-microbial agent herein is compatible with the water-soluble film of the pouch, i.e., not undesirably reacting with the film.

In one embodiment, the raw material form of the anti-microbial agent (hereinafter referred to as an “anti-microbial composition”) comprises less than 5%, preferably less than 1%, more preferably is substantially free, of water, by weight of the anti-microbial composition. Preferably, in addition to the anti-microbial agent, the anti-microbial composition also comprises an organic solvent, e.g., diethylene glycol, propylene glycol, glycerol, preferably diethylene glycol.

The anti-microbial agent is preferably a diphenyl ether, more preferably a hydroxyl diphenyl ether. The nonionic anti-microbial agent herein can be either halogenated or non-halogenated, but preferably is halogenated. Diphenyl ethers suitable for use herein are described from Col. 1, line 54 to Col. 5, line 12 in U.S. Pat. No. 7,041,631B, which is incorporated by reference.

In one embodiment, the nonionic anti-microbial agent is a hydroxyl diphenyl ether of formula (I):

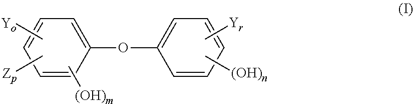

each Y is independently selected from chlorine, bromine, or fluorine, preferably is chlorine or bromine, more preferably is chlorine,

each Z is independently selected from SO₂H, NO₂, or C₁-C₄ alkyl,

r is 0, 1, 2, or 3, preferably is 1 or 2,

o is 0, 1, 2, or 3, preferably is 0, 1 or 2,

p is 0, 1, or 2, preferably is 0,

m is 1 or 2, preferably is 1, and

n is 0 or 1, preferably is 0.

In the above definition for formula (I), 0 means nil. For example, when p is 0, then there is no Z in formula (I). Each Y or Z could be the same or different. In one embodiment, o is 1, r is 2, and Y is chlorine or bromine. This embodiment could be: one chlorine atom bonds to a benzene ring while the bromine atom and the other chlorine atom bond to the other benzene ring; or the bromine atom bonds to a benzene ring while the two chlorine atoms bond to the other benzene ring.

Preferably, the nonionic anti-microbial agent herein is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan®HP100.

In addition to the diphenyl ether, other anti-microbial agents may also be present, provided that these are not present at a level which causes instability in the formulation. Among such useful further antimicrobial agents are chelating agents, which are particularly useful in reducing the resistance of Gram negative microbes in hard water. Acid biocides may also be present.

### Adjunct Ingredients

The detergent composition herein may comprise adjunct ingredients. Suitable adjunct ingredients include but are not limited to: anionic surfactants, nonionic surfactants, cationic surfactants, amphoteric surfactants, organic solvents, builders, chelating agents, rheology modifiers, dye transfer inhibiting agents, dispersants, enzymes, and enzyme stabilizers, catalytic materials, bleach activators, hydrogen peroxide, sources of hydrogen peroxide, preformed peracids, clay soil removal/anti-redeposition agents, brighteners, suds suppressors, dyes, photobleaches, perfume microcapsules, neat perfume oils, structure elasticizing agents, fabric softeners, carriers, processing aids, hueing agents, structurants, and/or pigments. In addition to the disclosure below, suitable examples of such other adjuncts and levels of use are found in U.S. Pat. Nos. 5,576,282, 6,306,812 B1 and 6,326,348 B1 that are incorporated by reference. The precise nature of these adjunct ingredients and the levels thereof in the detergent composition will depend on the physical form of the composition and the nature of the cleaning operation for which it is to be used.

In one embodiment, the liquid detergent composition herein further comprises a surfactant selected from the group consisting of anionic surfactant, nonionic surfactant, cationic surfactant, amphoteric surfactant, and a combination thereof. Preferably the composition comprises from 3% to 70%, preferably from 5% to 50%, more preferably from 10% to 40%, by weight of the composition, of an anionic surfactant, and from 1% to 20%, preferably from 2% to 18%, more preferably from 3% to 15%, by weight of the composition, of a nonionic surfactant.

In one embodiment, the composition comprises an anionic surfactant. Non-limiting examples of anionic surfactants include: linear alkylbenzene sulfonate (LAS), preferably C10-C16 LAS; C10-C20 primary, branched-chain and random alkyl sulfates (AS); C10-C18 secondary (2,3) alkyl sulfates; sulphated fatty alcohol ethoxylate (AES), preferably C10-C18 alkyl alkoxy sulfates (AExS) wherein preferably x is from 1-30, more preferably x is 1-3; C10-C18 alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, and WO 99/05244; methyl ester sulfonate (MES); and alpha-olefin sulfonate (AOS). Preferably, the composition comprises an anionic surfactant selected from the group consisting of LAS, AES, AS, and a combination thereof, more preferably selected from the group consisting of LAS, AES, and a combination thereof. In one preferred embodiment, the composition comprises an anionic surfactant system comprising AES and LAS. The total level of the anionic surfactant(s) may be from 3% to 70%, preferably present from 5% to 50%, more preferably from 10% to 40%, by weight of the composition, in the composition, by weight of the liquid detergent composition. In the execution where both AES and LAS are present in the composition, the weight ratio of the AES to LAS is from 0.1:1 to 10:1, preferably from 0.2:1 to 5:1, more preferably from 0.4:1 to 1:1.

In one embodiment, the composition herein comprises a nonionic surfactant, preferably an alkoxylated nonionic surfactant. Non-limiting examples of alkoxylated nonionic surfactants suitable for use herein include: C12-C18 alkyl ethoxylates, such as Neodol® nonionic surfactants available from Shell; C6-C12 alkyl phenol alkoxylates wherein the alkoxylate units are a mixture of ethyleneoxy and propyleneoxy units; C12-C18 alcohol and C6-C12 alkyl phenol condensates with ethylene oxide/propylene oxide block alkyl polyamine ethoxylates such as Pluronic® available from BASF; C14-C22 mid-chain branched alkyl alkoxylates, BAEx, wherein x is from 1-30, as discussed in U.S. Pat. No. 6,153,577, U.S. Pat. No. 6,020,303 and U.S. Pat. No. 6,093,856; alkylpolysaccharides as discussed in U.S. Pat. No. 4,565,647 Llenado; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408. Also useful herein as nonionic surfactants are alkoxylated ester surfactants such as those having the formula R1C(O)O(R2O)nR3 wherein R1 is selected from linear and branched C6-C22 alkyl or alkylene moieties; R2 is selected from C2H4 and C3H6 moieties and R3 is selected from H, CH3, C2H5 and C3H7 moieties; and n has a value between 1 and 20. Such alkoxylated ester surfactants include the fatty methyl ester ethoxylates (MEE) and are well-known in the art; see for example U.S. Pat. No. 6,071,873; U.S. Pat. No. 6,319,887; U.S. Pat. No. 6,384,009; U.S. Pat. No. 5,753,606; WO 01/10391, WO 96/23049.

In one embodiment, the alkoxylated nonionic surfactant herein is C6-C22 alkoxylated alcohol, preferably C8-C18 alkoxylated alcohol, more preferably C12-C16 alkoxylated alcohol. The C6-C22 alkoxylated alcohol is preferably an alkyl alkoxylated alcohol with an average degree of alkoxylation of from 1 to 50, preferably 3 to 30, more preferably from 5 to 20, even more preferably from 5 to 9. The alkoxylation herein may be ethoxylation, propoxylation, or a mixture thereof, but preferably is ethoxylation. In one embodiment, the alkoxylated nonionic surfactant is C6-C22 ethoxylated alcohol, preferably C8-C18 alcohol ethoxylated with an average of 5 to 20 moles of ethylene oxides, more preferably C12-C16 alcohol ethoxylated with an average of 5 to 9 moles of ethylene oxides. One preferred example of the alkoxylated nonionic surfactant is C12-C15 alcohol ethoxylated with an average of 7 moles of ethylene oxide, e.g., Neodol®25-7 commercially available from Shell.

In one embodiment, the composition herein comprises a cationic surfactant. Non-limiting examples of cationic surfactants include: the quaternary ammonium surfactants, which can have up to 26 carbon atoms include: alkoxylate quaternary ammonium (AQA) surfactants as discussed in U.S. Pat. No. 6,136,769; dimethyl hydroxyethyl quaternary ammonium as discussed in 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

In one embodiment, the composition herein comprises an amphoteric surfactant. Non-limiting examples of amphoteric surfactants include: derivatives of secondary and tertiary amines, derivatives of heterocyclic secondary and tertiary amines, or derivatives of quaternary ammonium, quaternary phosphonium or tertiary sulfonium compounds. Preferred examples include: betaine, including alkyl dimethyl betaine and cocodimethyl amidopropyl betaine, C8 to C18 (or C12 to C18) amine oxides and sulfo and hydroxy betaines, such as N-alkyl-N,N-dimethylammino-1-propane sulfonate where the alkyl group can be C8 to C18, or C10 to C14.

Preferably, the amphoteric surfactant herein is selected from water-soluble amine oxide surfactants. A useful amine oxide surfactant is:

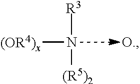

where R3 is a C8-22 alkyl, a C8-22 hydroxyalkyl, or a C8-22 alkyl phenyl group; each R4 is a C2-3 alkylene, or a C2-32 hydroxyalkylene group; x is from 0 to about 3; and each R5 is a C1-3 alkyl, a C1-3 hydroxyalkyl, or a polyethylene oxide containing from about 1 to about 3 EOs. Preferably, the amine oxide surfactant may be a C10-18 alkyl dimethyl amine oxide or a C8-12 alkoxy ethyl dihydroxy ethyl amine oxide.

In one embodiment, the composition herein further comprises a rheology modifier (also referred to as a “structurant” in certain situations), which functions to suspend and stabilize the microcapsules and to adjust the viscosity of the composition so as to be more applicable to the packaging assembly. The rheology modifier herein can be any known ingredient that is capable of suspending particles and/or adjusting rheology to a liquid composition, such as those disclosed in U.S. Patent Application Nos. 2006/0205631A1, 2005/0203213A1, and U.S. Pat. Nos. 7,294,611, 6,855,680. Preferably the rheology modifier is selected from the group consisting of hydroxy-containing crystalline material, polyacrylate, polysaccharide, polycarboxylate, alkali metal salt, alkaline earth metal salt, ammonium salt, alkanolammonium salt, C12-C20 fatty alcohol, di-benzylidene polyol acetal derivative (DBPA), di-amido gallant, a cationic polymer comprising a first structural unit derived from methacrylamide and a second structural unit derived from diallyl dimethyl ammonium chloride, and a combination thereof. Preferably, the rheology modifier is a hydroxy-containing crystalline material generally characterized as crystalline, hydroxyl-containing fatty acids, fatty esters and fatty waxes, such as castor oil and castor oil derivatives. More preferably the rheology modifier is a hydrogenated castor oil (HCO).

In a highly preferred embodiment, the liquid detergent composition of the present invention comprises:

a) from 0.03% to 0.5%, by weight of the composition, of the anti-microbial agent, wherein the anti-microbial agent is 4-4′-dichloro-2-hydroxy diphenyl ether;

b) from 5% to 19%, by weight of the cleaning composition, of water; and

c) from 10% to 40%, by weight of the composition, of an anionic surfactant, wherein the anionic surfactant is selected from the group consisting of AES, LAS, and a combination thereof.

### Composition Preparation

The liquid detergent composition of the present invention is generally prepared by conventional methods such as those known in the art of making liquid laundry detergent compositions. Such methods typically involve mixing the essential and optional ingredients in any desired order to a relatively uniform state, with or without heating, cooling, application of vacuum, and the like, thereby providing liquid detergent compositions containing ingredients in the requisite concentrations.

### Water-Soluble Pouch

The liquid detergent composition herein is contained within a water-soluble film thereby forming a water-soluble pouch. The pouch may be of such a size that it conveniently contains either a unit dose amount of the composition herein, suitable for the required operation, for example one wash, or only a partial dose, to allow a user greater flexibility to vary the amount used, e.g., depending on the size or degree of soiling of the wash load.

The pouch herein is typically a closed structure, made of the water-soluble film enclosing an internal volume which comprises the liquid detergent composition. The pouch can be of any form and shape which are suitable to hold and protect the composition, e.g. without allowing the release of the composition from the pouch prior to contact of the pouch to water. The exact execution will depend on factors like the type and amount of the composition in the pouch, the number of compartments in the pouch, the characteristics required for the water-soluble film to hold, protect, and release the composition.

The water-soluble film of the pouch can be of any suitable moisture level (i.e., water level in the film structure). A suitable moisture level herein means a level that is neither too low nor too high. It is generally known in the art that the film will rapidly absorb water from the atmosphere if the moisture level is too low while it will lose water if the moisture level is too high, both continuing until achieving equilibrium with the atmosphere, e.g., reaching a moisture level of around 8%. Neither the absorption of water nor the loss of water is good for pouch stability. In one embodiment, the water-soluble film has a moisture level of 4% to 15%, preferably 5% to 10%, more preferably 5% to 8%.

The water-soluble film herein preferably comprises a polymer. The film can be obtained from methods known in the art, e.g., by casting, blow molding, extrusion molding, injection molding of the polymer. Non-limiting examples of the polymer for making the water-soluble film include: polyvinyl alcohols (PVAs), polyvinyl pyrrolidone, polyalkylene oxides, (modified) cellulose, (modified) cellulose-ethers or -esters or -amides, polycarboxylic acids and salts including polyacrylates, copolymers of maleic/acrylic acids, polyaminoacids or peptides, polyamides including polyacrylamide, polysaccharides including starch and gelatine, natural gums such as xanthum and carragum. Preferably, the water-soluble film comprises a polymer selected from the group consisting of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, hydroxypropyl methyl cellulose (HPMC), and a combination thereof. Most preferably, the water-soluble film comprises a polyvinyl alcohol, e.g., film M8630 or M9467 commercially available from MonoSol. Suitable polymers for making the water-soluble film of the pouch can be found in U.S. Pat. No. 6,995,126.

In the execution of polyvinyl alcohol, the water-soluble film may be partially or fully alcoholised or hydrolysed. For example it may be from 40 to 100%, preferably 70 to 92%, more preferably 88% to 92%, alcoholised or hydrolysed. The degree of hydrolysis is known to influence the temperature at which the polyvinyl alcohol starts to dissolve in water. 88% hydrolysis corresponds to a film soluble in cold (i.e. room temperature) water, whereas 92% hydrolysis corresponds to a film soluble in warm water. An example of a preferred polyvinyl alcohol is ethyoxylated polyvinyl alcohol. The film may be cast, blown or extruded. It may also be unorientated, mono-axially oriented or bi-axially oriented.

In addition to the polymer, the water-soluble film may also comprise suitable additives such as plasticizers, lubricants, and colouring agents. Components which modify the properties of the polymer may also be added. Plasticizers are generally used in an amount of up to 35 wt %, for example from 5 to 35 wt %, preferably from 7 to 20 wt %, more preferably from 10 to 15 wt %. Lubricants are generally used in an amount of 0.5 to 5 wt %. The polymer is therefore generally used in an amount of from 60 to 94.5 wt %, based on the total amount of the composition used to form the film. Suitable plasticisers are, for example, pentaerythritols such as depentaerythritol, sorbitol, mannitol, glycerine and glycols such as glycerol, ethylene glycol and polyethylene glycol. Solids such as talc, stearic acid, magnesium stearate, silicon dioxide, zinc stearate or colloidal silica may also be used. It is also possible to include one or more particulate solids in the films in order to accelerate the rate of dissolution of the container. This solid may also be present in the contents of the container. Dissolution of the solid in water is sufficient, to cause an acceleration in the break-up of the container, particularly if a gas is generated, when the physical agitation caused may, for example, result in the virtually immediate release of the contents from the container. Examples of such solids are alkali or alkaline earth metal, such as sodium, potassium, magnesium or calcium, bicarbonate or carbonate, in conjunction with an acid. Suitable acids are, for example, acidic substances having carboxylic or sulfonic acid groups or salts thereof. Examples are cinnamic, tartaric, mandelic, fumaric, maleic, malic, palmoic, citric and naphthalene disulfonic acids.

The water-soluble film is generally cold water (20° C. or below) soluble, but may be insoluble in water at 20° C. and only become soluble in warm water or hot water having a temperature of 30° C., 40° C., 50° C. or even 60° C. In the case of polyvinyl alcohol, this parameter is determined by its degree of hydrolysis.

The pouch herein may comprise a single compartment or multiple compartments, preferably comprise multiple compartments, e.g., two compartments or three compartments. In the multi-compartment execution, the pouch comprises multiple films which form the multiple compartments, i.e., the inner volume of the multiple films is divided into the multiple compartments. Examples of these multi-compartment pouches are described in U.S. Pat. Nos. 4,973,416, 5,224,601, and 8,066,818. Multi-compartment pouches bring certain advantages. For example, the manufacturer is able to formulate, otherwise, incompatible ingredients into a single product or create a sequential release product to meet cleaning, softening or ingredient compatibility demands.

In a multi-compartment execution, it is preferably that at least two of the multiple compartments have different solubility under the same condition, releasing the compositions which they partially or totally envelop at different times, e.g., at different time points during a wash cycle. The term “solubility” herein is not intended to refer to total solubility of a film but to the point at which the pouch in the wash solution breaks to release its content. Difference in solubility of each compartment can be achieved by means of films made of different polymers, films of different thickness, or films which solubility is temperature dependent, or by properties of the compartment (e.g., size, weight, relative position of the compartment). One example of the means of obtaining delayed release by pouches with different compartments, where the compartments are made of films having different solubility are taught in WO 02/08380. In one preferred embodiment, the required liquid detergent composition is contained in a compartment that dissolves later than other compartments of the pouch during a wash cycle. This enables longer time of the nonionic anti-microbial agent and PMC being hold in the compartment, and therefore less amounts of the compounds being washed away during the wash cycle.

In the multi-compartment execution, the required liquid detergent composition is contained in one or more compartments of the multiple compartments, preferably in one compartment of the multiple compartments. The multiple compartments of the pouch may comprise either the same composition or different compositions. The term “different compositions” herein refer to compositions that differ in at least one ingredient. In one embodiment, each of the multiple compartments comprises the same composition, which is the liquid detergent composition required by the present invention. Alternatively, at least two of the multiple compartments of the pouch comprise two different compositions. In a preferred embodiment, each of the multiple compartments has different colors, e.g., comprising different dyes that impart different colors to the multiple compositions contained in the multiple compartments, thus being more appealing to users.

In another preferred embodiment, the pouch comprises three compartments, wherein the three compartments comprise a first compartment, a second compartment, and a third compartment. Preferably, the first compartment and the second compartment are placed side-by-side and superposed (i.e., placed above) onto the third compartment, wherein the required liquid detergent composition is preferably contained in the third compartment. When the required liquid detergent composition is contained in the third compartment, the first compartment and the second compartment may comprise either a liquid or solid composition. For example, the third compartment comprises the required liquid detergent composition, the first compartment comprises a first composition in a liquid form, and the second compartment comprises a second composition in a liquid form, wherein the first composition and the second composition are either the same or different. An alternative example is that, the third compartment comprises the required liquid detergent composition, the first compartment comprises a first composition in a liquid form, and the third compartment comprises a third composition in a solid form.

The pouch may be of such a size that it conveniently contains either a unit dose amount of the composition herein, suitable for the required operation, for example one wash, or only a partial dose, to allow a user greater flexibility to vary the amount used, e.g., depending on the size or degree of soiling of the wash load. In one embodiment, the pouch has an internal volume of from about 10 ml to about 50 ml, preferably from about 12 ml to about 30 ml, more preferably from about 15 to about 25 ml. The pouch can have a round, square, rectangular, or any other suitable shape. In particular, more suitable pouches have a square or rectangular or round base and a height of from about 1 cm to about 5 cm, preferably from about 1 cm to about 4 cm. In terms of weight, the pouch preferably has a weight of from about 5 grams to about 50 grams, more preferably from about 10 grams to about 40 grams, even more preferably from about 15 grams to about 30 grams.

The pouch of the present invention can be made by any suitable processes known in the art. Example processes of making the pouch can be found in U.S. Pat. Nos. 6,995,126, 7,127,874, 8,156,713, 7,386,971, 7,439,215, and US Patent Publication No. 2009/199877. For example, the multi-compartment pouch herein is obtainable by the process of closing an open compartment with a pre-sealed compartment, wherein the process forms a second seal on the pre-sealed compartment which is in a different position to the first seal of the pre-sealed compartment, as disclosed in U.S. Pat. No. 6,995,126. Alternatively, the multi-compartment pouch could be obtainable by the steps of: a) making a first compartment in a first pouch making unit having a first forming surface, wherein the first compartment is made by placing a water-soluble film on the surface of the first pouch making unit, the surface has moulds into which the water-soluble film is drawn to form an open compartment, the open compartment is then filled with a detergent composition, and preferably the resulting compartment is subsequently closed; b) making a second compartment in a second pouch making unit having a second forming surface, wherein the second compartment is made in a similar manner to the first compartment and preferably is subsequently closed; c) combining the first and second compartment wherein the first and second forming surfaces bring the first and second compartments into contact and exert pressure on them to seal the first and second compartments to form a pouch; and d) cutting the resulting pouches to produce individual pouches having multiple compartments, as disclosed in US Patent Publication No. 2009/199877.

In one aspect, the present invention is directed to a method of making a water-soluble pouch comprising a liquid detergent composition comprising the steps:

a) adding an anti-microbial composition into a liquid composition precursor to form the liquid detergent composition, wherein the anti-microbial composition comprises a nonionic anti-microbial agent and less than 5% of water by weight of the anti-microbial composition; and

b) encapsulating the liquid detergent composition with a water-soluble film to form the water-soluble pouch.

In step a), preferably the anti-microbial composition comprises less than 1%, more preferably is substantially free, of water, by weight of the anti-microbial composition. In one preferred embodiment, the nonionic anti-microbial agent is 4-4′-dichloro-2-hydroxy diphenyl ether.

In step b), preferably the encapsulated liquid detergent composition obtained comprises from 1% to 12%, more preferably from 3% to 11%, more preferably from 5% to 11%, by weight of the composition, of water.

In a highly preferred embodiment, the water-soluble pouch of the present invention comprises a water-soluble film and a liquid detergent composition contained within the water-soluble film, wherein the composition comprises:

a) from 0.03% to 0.5%, by weight of the composition, of the anti-microbial agent, wherein the anti-microbial agent is 4-4′-dichloro-2-hydroxy diphenyl ether;

b) from 5% to 10%, by weight of the cleaning composition, of water; and

c) from 10% to 40%, by weight of the composition, of an anionic surfactant, wherein the anionic surfactant is selected from the group consisting of AES, LAS, and a combination thereof, wherein the water-soluble film comprises a polyvinyl alcohol and has a moisture level of 5% to 8%.

### Method of Use

Another aspect of the present invention is directed to a method of using the water-soluble pouch to treat a fabric, with an anti-microbial benefit. The method comprises the step of administering one or more aforementioned pouches into a washing basin comprising water to form a washing solution. The washing solution in a laundry washing basin herein preferably has a volume from 1 L to 50 L, alternatively from 1 L to 20 L for hand washing and from 20 L to 50 L for machine washing. Preferably, the anti-microbial benefit herein is determined by the JISL 1902 method. The temperature of the washing solution preferably ranges from 5° C. to 60° C., more preferably from 20° C. to 50° C.

Preferably, the method herein further comprises the step of contacting a fabric with the washing solution, wherein the fabric is in need of an anti-microbial treatment. For example, the presence of gram positive bacteria and/or gram negative bacteria is suspected on the fabric. The step of contacting the fabric with the washing solution is preferably after the step of administering the liquid detergent composition in a washing basin.

### Test Method

Method for Determining of Stability Performance for Water-Soluble Pouches

The stability performance of water-soluble pouches is characterized by pouch tightness and pouch tensile stress data as described below.

Pouch Tightness

The overall tightness of a water-soluble pouch is defined as its compressed height under 10 N of force. A pouch that resists the force and only minimally decreases in height is considered to have good pouch tightness. Conversely, a pouch that more readily contracts under the force is considered to have poor pouch tightness.

During the test, Instron Testing Machine ESM301(L)-Mark-10 with a maximum load of 1.5 kN (commercially available from Instron Industrial Products, USA) is used. The machine comprises two compression plates, including a top compression plate and a bottom compression test, to exert a force onto a pouch. First put the test pouch in a plastic bag (150 mm*180 mm) with a closure. Close the bag, and remove the air from the bag. Then lay the bag with the pouch horizontally onto the bottom compression plate. Move the top compression plate from top to bottom until it touches the pouch and a force of 10 N is reached. Obtain the pouch tightness value (i.e., the compressed height) in millimeter when the top compression plate stops. The test is conducted in a room environment with a Relative Humidity (RH) of 30-40%. 5 replicates are conducted.

Pouch Tensile Stress

The tensile stress of a water-soluble pouch is defined as the stress needed for 100% elongation of the film for making the water-soluble pouch while the film has been immersed in a liquid composition that is designed for the pouch. Such, the test result from the method can indicate the impact of the liquid composition on the mechanical property of the film. Moreover, the tensile stress of the film at 100% elongation is a good measure for predicating pouch leakage response upon impact stress exposure.

1 Immersed Film Sample Preparation

Prepare a test film with a size of 12 cm*17 cm and 150 mL of a test liquid composition (the test film is designed to encapsulate the test liquid composition to form a water-soluble pouch). Prepare a glass container. Cover the bottom of the glass container with a thin layer of the liquid composition. Spread the test film on the liquid in the glass container, and gently push air bubbles trapped under the film towards the sides of the film. Pour the remaining liquid composition on top of the film, in such as way that the film is fully immersed into the liquid composition. Ensure that the film is free of wrinkles and that no air bubbles are in contact with the film.

Store the glass container with the immersed film for 5 days in an environment with a RH of 40% and at a temperature of 35° C. Then remove the film from the glass container and remove the excess of the liquid composition from the film. Put the film on top of a piece of paper, and then wipe the film thoroughly dry with another piece of dry paper. Cut the dried film into 5 strips, each having a length of 12 cm and a width of 2.5 cm. Thus, immersed film samples (the 5 strips of film) are obtained.

2. Film Elongation

In the test, Instron electromechanical testing machine 5567J4072 with a load capacity of 30 kN (commercially available from Instron Industrial Products, USA) is used. Elongate the immersed film sample, and then obtain the tensile stress at 100% elongation. The test is conducted in a room environment with a RH of 30-40% and at a temperature of 21° C. 5 replicates (the 5 strips of film obtained in step 1 used) are conducted.

Method for Determining of Anti-Microbial Efficacy for Detergent Compositions

The anti-microbial efficacy for detergent compositions is determined by the method as defined in the JISL 1902 method and described hereinafter.

1. Microorganism Preparation

A. Aseptically add certain amount of nutrient broth into a lyophilized culture of Staphylococcus aureus or Klebsiella pneumoniae. Dissolve and suspend the culture in the nutrient broth to obtain a suspension. Streak a loop of the suspension onto a nutrient agar plate, and incubate at 37° C. for 24 hours to obtain a first generation subculture of bacterial suspension. Transfer a loop of the first generation subculture of bacterial suspension into 20 mL of nutrient broth with shaking, and incubate at 37° C. for 24 hours to obtain a second generation subculture of bacterial suspension. Transfer 0.4 mL of the second generation subculture of bacterial suspension into another 20 mL of nutrient broth with shaking, and incubate at 37° C. for 3 hours to obtain a third generation subculture of bacterial suspension.
B. Dilute the third generation subculture of bacterial suspension by 1/20 diluted nutrient broth to 1×105 cells/mL to obtain a working culture.
C. Store the working culture at 4° C. The working culture cannot be stored overnight.

2. Fabric Washing

A. Boil two fabric strips each having a width of 5 cm and length of 2.5 m (32 yarn/cm×32 yarn/cm, 100% plain weave cotton) in 3 L of a solution for 1 hour. The solution is prepared by 1.5 g of a nonionic soaked agent, 1.5 g of sodium carbonate, and 3000 mL of distilled water. The nonionic soaked agent is prepared by 5.0 g of alkylphenol ethoxylate, 5 g of sodium carbonate, and 1000 mL of distilled water. Rinse the fabric strips in boiled deionized water for 5 minutes. Place the fabric strips in cool deionized water for 5 minutes, and indoor dry. One fabric strip serves as a test fabric strip for following steps 2B-2I, and the other fabric strip is used as control (without experiencing steps 2B-2I).
B. Fix one end of the test fabric strip obtained from step 2A onto a stainless steel spindle at an outer position along the horizontal extension of the stainless steel spindle. The stainless steel spindle has 3 horizontal stands that are connected to one another. Wrap the test fabric strip around the 3 horizontal stands of the stainless steel spindle with sufficient tension to obtain a fabric wrapped spindle having 12 laps of fabric. Fix the other end of the test fabric strip onto the outer lap of the 12 laps of fabric via a pin. Sterilize the fabric wrapped spindle with pressure steam at 121° C. for 15 minutes.
C. Dissolve 5.903 g of calcium chloride dihydrate and 2.721 g of magnesium chloride hexahydrate in 100 mL of distilled water, and then sterilize the mixture with pressure steam at 121° C. for 20 minutes. Add 1 mL of the mixture into 1 L of distilled water to obtain a hard water solution.
D. Add sufficient amount of sample into 1 L of the hard water solution obtained from step 2C to obtain a solution having a concentration of 2069 ppm. Mix the solution by a magnetic stirrer for 4 minutes. Distribute 250 mL of the mixed solution into an exposure chamber to obtain a washing solution. Place the exposure chamber in a water bath and achieve the test temperature of (25±1°) C. The exposure chamber is then sterilized with pressure steam at 121° C. for 15 minutes.
E. Aseptically soak the fabric wrapped spindle obtained from step 2B into the washing solution in the exposure chamber, and close the exposure chamber with a lid.
F. Fix the exposure chamber onto a tumbler. Rotate the tumbler for 10 minutes. Then remove the fabric wrapped spindle from the exposure chamber. Place the fabric wrapped spindle in Haier iwash-1p Top Load Washing Machine and rinse for 2 minutes.
G. Discard the washing solution from the exposure chamber, and then add 250 mL of sterilized distilled water into the exposure chamber. Soak the rinsed fabric wrapped spindle in the newly added distilled water in the exposure chamber. Rotate the tumbler for 3 minutes.
H. Repeat step 2G.
I. Aseptically remove the fabric wrapped spindle out of the exposure chamber and remove the test fabric strip from the spindle. Air dry the test fabric strip overnight.

3. Fabric Incubation

A. Cut the washed test fabric strip obtained from step 2I to square pieces having a side length of 2 cm. 3 sets of 0.4 g of the pieces serve as specimens for the following steps.
B. Put each set of specimens into a vial, and then sterilize the specimens with pressure steam at 121° C. for 15 minutes. After the sterilization, dry the specimens for 1 hour in a clean bench without a cap.
C. Inoculate 0.2 mL of the working culture obtained from step 1C onto each dried specimen. Incubate the vials containing the inoculated specimens at 37° C. for 18 hours.
D. Extract survivors on the incubated specimens, plate with nutrient agar, and incubate at 37° C. for 24-48 hours. Count the total colony-forming units (CFU) of each set of specimens, and obtain average results of the 3 sets. Take the log 10 value of CFU value as Mb.
E. In steps 3A-3D, use the fabric strip obtained from step 2A (that does not experience steps 2B-2I) as control. Take the log 10 value of CFU value as Ma.

4. Calculation of Bacteriostatic Activity Value

Bacteriostatic Activity Value=Mb−Ma

A Bacteriostatic Activity Value of greater than 2.2 represents good anti-microbial efficacy. And a Bacteriostatic Activity Value of lower then 2.2 indicates unacceptable poor anti-microbial efficacy.

### EXAMPLE

The Examples herein are meant to exemplify the present invention but are not used to limit or otherwise define the scope of the present invention. Examples 1 and 3 are examples according to the present inventions, and Examples 2A, 2B, 4A, and 4B are comparative examples.

### Examples 1 and 2

### One-Compartment Pouches Comprising a Liquid Laundry Detergent Composition

The composition as shown in Table 1 is each introduced into a pouch having one compartment and is made comprising the listed ingredients in the listed proportions (weight %). The pouches of Example 1 and Comparative Examples 2A and 2B have the same compositional weight of 16.1 grams. The film used is MonoSol M9467 film with a thickness of 76 μm as supplied by MonoSol.

TABLE 1

| | | Comparative | Comparative |
|---|---|---|---|
| | 1 | 2A | 2B |
| C₁₁-C₁₃LAS | 19.1 | 19.2 | 16.8 |
| C₁₂-C₁₄AE₁₋₃S | 9.1 | 9.1 | 8.0 |
| Neodol ®25-7 a | 15.0 | 15.1 | 13.3 |
| Citric acid | 0.7 | 0.7 | 0.6 |
| C₁₂-C₁₈ fatty acid | 6.3 | 6.3 | 5.5 |
| HEDP b | 1.6 | 1.6 | 1.4 |
| Propylene glycol | 18.4 | 18.1 | 16.0 |
| Glycerol | 1.5 | 1.6 | 1.4 |
| Dipropylene glycol | 3.1 | 3.1 | 2.7 |
| Polyethyleneimine | 4.6 | 4.7 | 4.0 |
| ethoxylate c | | | |
| Potassium sulfite | 0.4 | 0.4 | 0.4 |
| Monoethanolamine | 8.7 | 8.7 | 7.6 |
| Magnesium chloride | 0.3 | 0.3 | 0.3 |
| Sodium formate | 0.1 | 0.1 | 0.1 |
| Brightener | 0.4 | 0.4 | 0.4 |
| Protease | 0.06 | 0.06 | 0.06 |
| Tinosan ®HP100 d | 0.15 | 0 | 0 |
| Cationic anti-microbial | 0 | 0 | 4.3 |
| agent e | | | |
| Hydrogenated castor | 0.13 | 0.13 | 0.13 |
| oil | | | |
| Dye | 0 | 0 | 0 |
| Perfume oil | 1.8 | 1.8 | 1.8 |
| Water | Add to 100 | Add to 100 | Add to 100 |

a Neodol ®25-7 is C₁₂-C₁₅ alcohol ethoxylated with an average of 7 moles of ethylene oxide as a nonionic surfactant, available from Shell
b 1-hydroxyethane-1,1′-diphosphonic acid as a chelant
c Polyethyleneimine ethoxylate having a PEI backbone of MWₙ of about 600 and side chains of (EO)₂₀
d Tinosan ®HP100 is 4-4′-dichloro-2-hydroxy diphenyl ether, available from BASF
e The cationic anti-microbial agent used herein is lauryl trimethyl ammonium chloride

Preparation of the pouches of Examples 1, 2A, and 2B

The pouches of Examples 1, 2A, and 2B are prepared by the following steps:

1. Composition Preparation

a) Mixing a combination of HEDP, propylene glycol, and water in a mixer by applying a shear of 200 rpm, and keeping the temperature of the combination under 45° C.;
b) adding sodium formate, monoethanolamine, Neodol®25-7, glycerol, dipropylene glycol, potassium sulfite, C₁₁-C₁₃ LAS, citric acid, C₁₂-C₁₈ fatty acid, C₁₂-C₁₄AE₁₋₃S, Tinosan®HP100 (if any), and cationic anti-microbial agent (if any) in sequence into the combination obtained in step a), keeping on mixing by applying a shear of 200 rpm, adjusting pH with monoethanolamine to 7.4. In particular, when present, Tinosan®HP100 is added as a nonionic anti-microbial composition (raw material) that comprises, by weight of the anti-microbial composition, about 70% of propylene glycol as a solvent and that is free of water, while the cationic anti-microbial agent is added as a cationic anti-microbial composition (raw material) that comprises, by weight of the anti-microbial composition, about 63% of water;
c) adding polyethyleneimine ethoxylate, magnesium chloride, brightener, protease, dye, and neat perfume oil into the combination obtained in step b); and
d) adding monoethanolamine and hydrogenated castor oil, thus forming a liquid laundry detergent composition that will be later contained in a water-soluble film,

wherein in the composition, each ingredient is present in the amount as specified for Examples 1, 2A, and 2B in Table 1.

2. Pouch Manufacturing

a) A first piece of MonoSol M9467 film is placed on top of a small mould and fixed in place. The small mould consists of a hemispherical shape and has a diameter of 33 mm and a depth of 14.5 mm A 1 mm thick layer of rubber is present around the edges of the mould. The mould has some holes in the mould material to allow a vacuum to be applied to pull the film into the mould and pull the film flush with the inner surface of the mould. The liquid laundry detergent composition obtained from above step 1d) is poured into the mould;
b) A second piece of MonoSol M9467 film is placed over the top of the small mould with the liquid laundry detergent composition and sealed to the first piece of film by applying a metal ring having an inner diameter of 34 mm and heating that metal under moderate pressure onto the ring of rubber at the edge of the mould to heat-seal the two pieces of film together to form a sealed compartment comprising the liquid laundry detergent. The metal ring is typically heated to a temperature of from 135° C. to 150° C. and applied for up to 5 seconds. The sealed compartment has a 75 mm rim of the film which extends in an outwardly direction from the seal away from the centre of the pre-sealed compartment so that the sealed compartment can be fixed into place and completely cover the opening of a mould with a larger diameter of 48.5 mm. A one-compartment pouch comprising a liquid laundry detergent composition is thereby formed.

### Examples 3 and 4

### Three-Compartment Pouches Comprising Liquid Laundry Detergent Compositions

The compositions as shown in Table 2 are introduced into a three-compartment pouch having two side-by-side compartments (the 1^{St} compartment and 2^{nd} compartment) superposed onto a third compartment (the 3^{rd} compartment). The compositions are made comprising the listed ingredients in the listed proportions (weight % measured by weight of the composition in the respective compartment, rather than by weight of the whole pouch). All of the compositions contained in the 1^{st} compartment, 2^{nd} compartment, and 3^{rd} compartment of Examples 3, 4A, and 4B are in liquid forms (hereinafter referred to as 1^{st} composition, 2^{nd} composition, and 3^{rd} composition, respectively). For Example 3, the required liquid detergent composition that comprises Tinosan®HP100 is contained in the 3^{rd} compartment. However, for Comparative Examples 4A and 4B, none of the liquid detergent compositions contained in all the three compartments fall within the scope of the present invention. Specifically, the 3^{rd} composition of Comparative Example 4A comprises no anti-microbial agents, and the 3^{rd} composition of Comparative Example 4B comprises a cationic anti-microbial agent. The 1^{st} and 2^{nd} compositions of Comparative Examples 4A and 4B are the same as those of Example 3, respectively.

The pouches of Examples 3, 4A, and 4B have the same total compositional weight of 19.5 grams, in which the compositions contained in the 1^{st} and 2^{nd} compartments each weigh 1.7 grams and the composition contained in the 3^{rd} compartment weighs 16.1 grams. The film used is MonoSol M9467 film with a thickness of 76 um as supplied by MonoSol.

TABLE 2

| | 1^{st} | 2^{nd} | 3^{rd} |
|---|---|---|---|
| | Compartment | Compartment | Compartment |
| 3 | | | |
| C₁₁-C₁₃LAS | 19.8 | 19.4 | 19.1 |
| C₁₂-C₁₄AE₁₋₃S | 9.6 | 9.3 | 9.1 |
| Neodol ®25-7 a | 14.1 | 13.7 | 15.0 |
| Citric acid | 0.7 | 0.7 | 0.7 |
| C₁₂-C₁₈ fatty acid | 6.6 | 6.4 | 6.3 |
| HEDP b | 1.7 | 1.7 | 1.6 |
| Propylene glycol | 19.3 | 19.0 | 18.4 |
| Glycerol | 1.6 | 1.6 | 1.5 |
| Dipropylene glycol | 3.2 | 3.2 | 3.1 |
| Polyethyleneimine | 4.9 | 4.7 | 4.6 |
| ethoxylate c | | | |
| Potassium sulfite | 0.1 | 0.4 | 0.4 |
| Monoethanolamine | 9.1 | 8.8 | 8.7 |
| Magnesium chloride | 0.3 | 0.3 | 0.3 |
| Sodium formate | 0.1 | 0.1 | 0.1 |
| Brightener | 0.02 | 0.02 | 0.4 |
| Protease | 0 | 0 | 0.06 |
| Tinosan ®HP100 d | 0 | 0 | 0.15 |
| Cationic anti-microbial | 0 | 0 | 0 |
| agent e | | | |
| Hydrogenated castor | 0.1 | 0.1 | 0.13 |
| oil | | | |
| Dye | 0.4 | 1.6 | 0 |
| Perfume oil | 0 | 0 | 1.8 |
| Water | Add to 100 | Add to 100 | Add to 100 |
| Comparative 4A | | | |
| C₁₁-C₁₃LAS | 19.8 | 19.4 | 19.2 |
| C₁₂-C₁₄AE₁₋₃S | 9.6 | 9.3 | 9.1 |
| Neodol ®25-7 a | 14.1 | 13.7 | 15.1 |
| Citric acid | 0.7 | 0.7 | 0.7 |
| C₁₂-C₁₈ fatty acid | 6.6 | 6.4 | 6.3 |
| HEDP b | 1.7 | 1.7 | 1.6 |
| Propylene glycol | 19.3 | 19.0 | 18.1 |
| Glycerol | 1.6 | 1.6 | 1.6 |
| Dipropylene glycol | 3.2 | 3.2 | 3.1 |
| Polyethyleneimine | 4.9 | 4.7 | 4.7 |
| ethoxylate c | | | |
| Potassium sulfite | 0.1 | 0.4 | 0.4 |
| Monoethanolamine | 9.1 | 8.8 | 8.7 |
| Magnesium chloride | 0.3 | 0.3 | 0.3 |
| Sodium formate | 0.1 | 0.1 | 0.1 |
| Brightener | 0.02 | 0.02 | 0.4 |
| Protease | 0 | 0 | 0.06 |
| Tinosan ®HP100 d | 0 | 0 | 0 |
| Cationic anti-microbial | 0 | 0 | 0 |
| agent e | | | |
| Hydrogenated castor | 0.1 | 0.1 | 0.13 |
| oil | | | |
| Dye | 0.4 | 1.6 | 0 |
| Perfume oil | 0 | 0 | 1.8 |
| Water | Add to 100 | Add to 100 | Add to 100 |
| Comparative 4B | | | |
| C₁₁-C₁₃LAS | 19.8 | 19.4 | 16.8 |
| C₁₂-C₁₄AE₁₋₃S | 9.6 | 9.3 | 8.0 |
| Neodol ®25-7 a | 14.1 | 13.7 | 13.3 |
| Citric acid | 0.7 | 0.7 | 0.6 |
| C₁₂-C₁₈ fatty acid | 6.6 | 6.4 | 5.5 |
| HEDP b | 1.7 | 1.7 | 1.4 |
| Propylene glycol | 19.3 | 19.0 | 16.0 |
| Glycerol | 1.6 | 1.6 | 1.4 |
| Dipropylene glycol | 3.2 | 3.2 | 2.7 |
| Polyethyleneimine | 4.9 | 4.7 | 4.0 |
| ethoxylate c | | | |
| Potassium sulfite | 0.1 | 0.4 | 0.4 |
| Monoethanolamine | 9.1 | 8.8 | 7.6 |
| Magnesium chloride | 0.3 | 0.3 | 0.3 |
| Sodium formate | 0.1 | 0.1 | 0.1 |
| Brightener | 0.02 | 0.02 | 0.4 |
| Protease | 0 | 0 | 0.06 |
| Tinosan ®HP100 d | 0 | 0 | 0 |
| Cationic anti-microbial | 0 | 0 | 4.3 |
| agent e | | | |
| Hydrogenated castor | 0.1 | 0.1 | 0.13 |
| oil | | | |
| Dye | 0.4 | 1.6 | 0 |
| Perfume oil | 0 | 0 | 1.8 |
| Water | Add to 100 | Add to 100 | Add to 100 |

a Neodol ®25-7 is C₁₂-C₁₅ alcohol ethoxylated with an average of 7 moles of ethylene oxide as a nonionic surfactant, available from Shell
b 1-hydroxyethane-1,1′-diphosphonic acid as a chelant
c Polyethyleneimine ethoxylate having a PEI backbone of MWₙ of about 600 and side chains of (EO)₂₀
d Tinosan ®HP100 is 4-4′-dichloro-2-hydroxy diphenyl ether, available from BASF
e The cationic anti-microbial agent used herein is lauryl trimethyl ammonium chloride

Preparation of the pouches of Examples 3, 4A, and 4B

The pouches of Examples 3, 4A, and 4B are prepared by the following steps:

1. Composition Preparation

The compositions contained in the 1^{st} compartment, 2^{nd} compartment, and 3^{rd} compartment of Examples 3, 4A, and 4B are prepared by the same steps as specified in step 1 of Examples 1-2, respectively, except for that each ingredient is present in the amount as specified for Examples 3, 4A, and 4B in Table 2.

2. Pouch Manufacturing

a) The 3^{rd} compartment is made using a first pouch making unit that has a first forming surface, wherein the first forming surface is a horizontal moving forming surface comprising a plurality of single cavity moulds. A first piece of MonoSol M9467 film gets laid down on the first forming surface and drawn into the moulds by vacuum to form recesses which are subsequently filled with the 3^{rd} composition obtained from above step 1. The 3^{rd} compartment is thereby formed;
b) The 1^{st} and 2^{nd} compartments are made using a second pouch making unit having a second forming surface, wherein the second forming surface is a circular rotating forming surface comprising a plurality of dual-cavity moulds. A second piece of MonoSol M9467 film gets laid down on the second forming surface and drawn into the dual-cavity moulds by vacuum. The 1^{st} and 2^{nd} compositions obtained from above step 1 are dosed into the two different cavities to form the 1^{st} and 2^{nd} compartments, at the top of the circular forming surface. A third piece of MonoSol M9467 film is wetted on a side, with the wetted side placed on top of the 1^{st} and 2^{nd} compartments, thereby sealing to close the 1^{st} and 2^{nd} compartments;
c) water is applied on the outer side of the third piece of film. When the 1^{st} and 2^{nd} compartments reach the lowest point of the circular surface, they are brought into contact with the 1^{st} compartment and sealed due to pressure exerted by the first and second forming surfaces; and
d) the resulting pouches are cut to produce individual multi-compartment pouches.

Comparative Data of Examples 3-4 on Anti-microbial Efficacy Comparative experiments of measuring the anti-microbial efficacy of the pouches of Example 3 and Comparative Examples 4A-4B are conducted, according to the JISL 1902 method as described hereinabove. Specifically, the pouch is added in step 2D of the method as sample. Table 3 shows Bacteriostatic Activity Values against Staphylococcus aureus (a Gram positive bacterium) and Klebsiella pneumoniae (a Gram negative bacterium).

TABLE 3

| | Bacteriostatic Activity | Bacteriostatic Activity |
|---|---|---|
| | Value against | Value against |
| Example | S. aureus | K. pneumoniae |
| 3 | 3.09 | 3.17 |
| Comparative 4A | 0.08 | 0.04 |
| Comparative 4B | 2.56 | −0.09 |

As shown in Table 3, the pouch according to the present invention (Example 3) demonstrates excellent anti-microbial efficacy against both Gram positive and Gram negative bacteria. In sharp contrast, the pouch of Comparative Example 4B that contains a cationic anti-microbial agent fails to provide anti-microbial efficacy against Gram negative bacteria, and the pouch of Comparative Example 4A that is free of anti-microbial agent does not provide any anti-microbial benefit.

Comparative Data on Pouch Tightness

Comparative experiments of measuring the tightness of the pouches of Example 3 and Comparative Examples 4A and 4B are conducted, according to the test method for pouch tightness as described hereinabove. Specifically, the pouch tightness is tested under the temperature of 20° C. and 32° C., respectively. The experimental results (compressed height of the pouch under 10 N of force) are shown in Table 4.

TABLE 4

| Example | 20° C. | 32° C. |
|---|---|---|
| 3 | 18.16 mm | 17.69 mm |
| Comparative 4A | 18.17 mm | 17.76 mm |
| Comparative 4B | 16.57 mm | 16.19 mm |

As shown in Table 4, Example 3 demonstrates improved pouch tightness over Comparative Example 4B that contains a cationic anti-microbial agent, whilst having comparative pouch tightness over Comparative Example 4A that is free of an anti-microbial agent.

Comparative Data on Pouch Tensile Stress

Comparative experiments of measuring the tensile stress of the pouches of Example 1 and Comparative Examples 2A and 2B are conducted, according to the test method for pouch tensile stress as described hereinabove. Specifically, the film for making the pouches (M9467) is immersed in the liquid laundry detergent composition of each example, and then the tensile stress of the immersed film at 100% elongation is measured. Also, the tensile stress of the film that is not immersed (hereinafter referred to as “virgin film”) is measured at 100% elongation. The experimental results are shown in Table 5.

TABLE 5

| Example | Tensile Stress |
|---|---|
| 1 | 12.37% |
| Virgin film | 11.07% |
| Comparative 2A | 13.02% |
| Comparative 2B | 8.39% |

As shown in Table 5, Example 1 demonstrates improved pouch tensile stress over both Virgin film and Comparative Example 2B that contains a cationic anti-microbial agent, whilst having comparative tensile stress over Comparative Example 2A that is free of an anti-microbial agent.

Unless otherwise indicated, all percentages, ratios, and proportions are calculated based on weight of the total composition. All temperatures are in degrees Celsius (° C.) unless otherwise indicated. All measurements made are at 25° C., unless otherwise designated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A water-soluble pouch, comprising a water-soluble film and a liquid detergent composition contained within said water-soluble film, wherein the composition comprises:
a) from about 0.001% to about 3%, by weight of the composition, of a nonionic anti-microbial agent;
b) from about 1% to about 12%, by weight of the composition, of water; and
c) from about 3% to about 70%, by weight of the composition, of an anionic surfactant;
and wherein the water-soluble film comprises polyvinyl alcohol.

2. The pouch according to claim 1, wherein said nonionic anti-microbial agent is a diphenyl ether.

3. The pouch according to claim 2, wherein said nonionic anti-microbial agent is a hydroxyl diphenyl ether compound of formula (I): 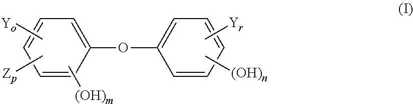
wherein:
each Y is independently selected from chlorine, bromine, or fluorine,
each Z is independently selected from SO₂H, NO₂, or C₁-C₄ alkyl,
r is 0, 1, 2, or 3,
o is 0, 1, 2, or 3,
p is 0, 1, or 2,
m is 1 or 2, and
n is 0 or 1.

4. The pouch according to claim 3, wherein said nonionic anti-microbial agent is selected from the group consisting of 4-4′-dichloro-2-hydroxy diphenyl ether, 2,4,4′-trichloro-2′-hydroxy diphenyl ether, and a combination thereof, preferably said nonionic anti-microbial agent is 4-4′-dichloro-2-hydroxy diphenyl ether.

5. The pouch according to claim 1, wherein said nonionic anti-microbial agent is present from about 0.01% to about 1%, by weight of the composition, and said water is present from about 3% to about 11%, by weight of the composition.

6. The pouch according to claim 1, wherein said water-soluble film has a moisture level of about 4% to about 15%.

7. (canceled)

8. (canceled)

9. The pouch according to claim 1, comprising multiple compartments, wherein the composition is contained in one compartment of said multiple compartments.

10. The pouch according to claim 9, comprising three compartments, wherein said three compartments comprise a first compartment, a second compartment, and a third compartment, wherein said first compartment and said second compartment are placed side-by-side and superposed onto said third compartment, and wherein the composition is contained in said third compartment.

11. The pouch according to claim 1, comprising:
a) from about 0.03% to about 0.5%, by weight of the composition, of said nonionic anti-microbial agent, wherein said nonionic anti-microbial agent is 4-4′-dichloro-2-hydroxy diphenyl ether;
b) from about 5% to about 10%, by weight of the composition, of water; and
c) from about 10% to about 40%, by weight of the composition, of an anionic surfactant, wherein said anionic surfactant is selected from the group consisting of an alkyl ethoxy sulfate (AES), a linear alkylbenzene sulfonate (LAS), and a combination thereof.

12. A method of making a water-soluble pouch comprising a liquid detergent composition comprising the steps:
a) providing an anti-microbial composition, wherein said anti-microbial composition comprises:
a nonionic anti-microbial agent,
an organic solvent, and
less than 5% of water by weight of the anti-microbial composition;
b) adding the anti-microbial composition into a liquid composition precursor comprising anionic surfactant to form the liquid detergent composition; and
c) encapsulating the liquid detergent composition with a water-soluble film to form the water-soluble pouch, wherein the encapsulated liquid detergent composition comprises from about 3% to about 70%, by weight of the encapsulated liquid detergent composition, of an anionic surfactant, and wherein the water-soluble film comprises polyvinyl alcohol.

13. The method of claim 12, wherein the encapsulated liquid detergent composition comprises from about 1% to about 12%, by weight of the encapsulated liquid detergent composition, of water.

14. The method of claim 12, wherein the organic solvent is selected from the group consisting of diethylene glycol, propylene glycol, glycerol, and mixtures thereof.

15. The method of claim 12, where the organic solvent comprises diethylene glycol.

16. The method of claim 12, wherein the nonionic anti-microbial agent is 4-4′-dichloro-2-hydroxy diphenyl ether.
